(19) United States
(12) Patent Application Publication
(10) Pub. No.: US 2012/0229561 A1
(43) Pub. Date: Sep. 13, 2012

(54) LIQUID EJECTING HEAD MODULE AND LIQUID EJECTING APPARATUS

(76) Inventors: Hiroyuki Ishii, Suwa-shi (JP); Shigeki Suzuki, Suwa-shi (JP); Hiroyuki Kobayashi, Suwa-shi (JP); Hiroshige Owaki, Suwa-shi (JP)

(21) Appl. No.: 13/414,433

(22) Filed: Mar. 7, 2012

(30) Foreign Application Priority Data
Mar. 8, 2011 (JP) 2011-050861

(51) Int. Cl. B41J 2/14; B41J 2/165

(52) U.S. Cl. 347/29; 347/47

(57) ABSTRACT

A head module includes a head unit having a plurality of heads, a carriage to which the head unit is anchored and that moves in a first direction relative to a recording sheet, and a grounding member that electrically connects the heads to the carriage; the heads are each provided with a cover head that covers first side surfaces and second side surfaces of the heads. Plate-shaped contact portions of the grounding member are caused to make contact with side wall portions of the cover head that are parallel to the first direction.

### BACKGROUND

1. Technical Field

The present invention relates to liquid ejecting head modules and liquid ejecting apparatuses provided with liquid ejecting heads that eject a liquid through nozzle openings, and particularly relates to ink jet recording head modules and ink jet recording apparatuses.

2. Related Art

Liquid ejecting apparatuses, represented by ink jet recording apparatuses such as ink jet printers or plotters, include liquid ejecting heads (called simply “heads” hereinafter) that eject a liquid such as ink that is held in a cartridge, a tank, or the like.

It is difficult to achieve a longer length (that is, more nozzles) by arranging the nozzle openings, increase the nozzle density, and so on through the head alone. This is because an increase in the size of the head leads to a drop in the yield and an increase in the manufacturing costs. Accordingly, a liquid ejecting head unit (called simply a “head unit” hereinafter), in which a unit is created by anchoring a plurality of heads to a common plate that serves as a holding member, has been proposed (for example, see International Publication WO/2004/022344).

Assuming that the direction in which the head unit moves relative to an ejection target medium such as paper is taken as a first direction, and the direction orthogonal to the first direction is taken as a second direction, with such a head unit, the heads are disposed in a staggered shape in the second direction. By disposing the heads in this manner, it is possible to form lengthened nozzle rows at a constant pitch in the second direction.

In order to achieve a further lengthening and densification of the nozzle openings, a liquid ejecting head module (also called simply a “head module” hereinafter) in which a plurality of the aforementioned head units are arranged on an anchoring member (such as a carriage) has been proposed.

By using a head module in which a plurality of head units are arranged rather than mounting many heads in a single head unit, it is possible to lengthen nozzle rows beyond the length of the head units, increase the density of the nozzle openings, and so on, without being limited by the nozzle row length of a single head unit.

With such a head module, there is a risk of the metal components of which the head is configured becoming charged by static electricity from a recording medium such as recording paper, from external causes, and so on, which can lead to malfunctions in pressure conversion elements for imparting pressure on ink, driving chips for driving the pressure conversion elements, and so on. Such problems occur with ease particularly in the case where the nozzle plate in which the nozzle openings are provided is formed of a metal material or the like.

Accordingly, the heads are suppressed from becoming charged by electrically connecting the heads to, for example, the carriage. Specifically, the heads are grounded in the following manner. Each head is provided with a metallic protective member that covers the peripheral edges of the nozzle plate so that the nozzle openings are exposed and that is bent toward the side surface of the head. A grounding member configured of a plate-shaped piece of metal is caused to make surface contact with the side surface of the head in the direction parallel to the second direction, and the grounding member is connected to the carriage. Through this, the head is grounded to the liquid ejecting apparatus itself through the protective member, the grounding member, and the carriage, thus preventing the head from becoming charged.

With the configuration of the head module, it is desirable to cause the grounding member to come into contact with the side surface of the head parallel to the second direction. This is because the nozzle openings are lengthened in the second direction, and thus the head itself is also lengthened in the second direction; furthermore, the protective member that covers the head is also lengthened in the second direction, and thus a sufficient grounding surface area can be secured between the protective member and the grounding member.

However, because this results in the grounding member being disposed parallel to the second direction, the region that makes contact with the ejection target medium that moves along the first direction is also broadened, which increases the chance that the ejection target medium will make contact with the grounding member and become jammed.

Meanwhile, it is possible to bring the head into contact with the carriage and ground the head without using a grounding member. However, this increases the load placed on the head, which in turn increases the burden on the constituent elements of the head. In addition, there is a risk that the head will experience positional skew due to the load, which in turn will affect the precision with which ink is ejected. Furthermore, when positioning a head relative to the carriage, there is the risk that the precision of the positioning will drop due to the influence of the dimensional tolerance of the protective member, and thus it is undesirable to directly ground the head to the carriage.

It should be noted that such problems are not limited to head modules including ink jet recording heads that eject ink, and are also present in liquid ejecting head modules including liquid ejecting heads that eject liquids aside from ink.

### SUMMARY

It is an advantage of some aspects of the invention to provide a liquid ejecting head module and a liquid ejecting apparatus capable of preventing a liquid ejecting head from becoming charged and capable of preventing an ejection target medium from coming into contact with a grounding member.

A liquid ejecting head module according to an aspect of the invention includes: a head unit having a plurality of liquid ejecting heads, each liquid ejecting head having a liquid ejecting surface in which nozzle openings that eject a liquid are provided; an anchoring member, to which the head unit is anchored, that moves in a first direction relative to an ejection target medium onto which the liquid is ejected; and a grounding member that electrically connects the liquid ejecting heads to the anchoring member. A protective member that covers the side surfaces of the liquid ejecting heads that are orthogonal to the liquid ejecting surfaces is provided for each of the liquid ejecting heads; and the grounding member makes contact with the protective members, and the length of a second direction component of the grounding member that is orthogonal to the first direction is shorter than the length of the first direction component.

According to this aspect, the liquid ejecting heads are electrically connected to the anchoring member via the grounding member, and thus a charge that has built up in the liquid ejecting heads is discharged. The length of the second direction component of the grounding member is shorter than the length of the first direction component, which is the direction in which the anchoring member moves relative to the ejection target medium, and thus it is difficult for the grounding member to come into contact with the ejection target medium. Accordingly, the ejection target medium is prevented from making contact with the grounding member and jamming.

Here, it is preferable for the grounding member to be formed in a plate shape, and to make contact with surfaces of the protective members that are parallel to the first direction. Through this, the length of the second direction component of the grounding member is essentially equivalent to the thickness of the plate, and thus it is possible to prevent, with even more certainty, the ejection target medium from making contact with the grounding member and jamming.

In addition, it is preferable for the head unit to include a holding member that holds the plurality of liquid ejecting heads on one surface; a cap positioning portion that regulates the positions of caps attached to corresponding liquid ejecting surfaces of the liquid ejecting heads to be provided on the one surface of the holding member; and the height of the grounding member from the one surface to be lower than the height of the cap positioning portion. Through this, it is possible to prevent, with even more certainty, the ejection target medium from making contact with the grounding member and jamming.

In addition, it is preferable for the grounding member to make contact with each protective member of the plurality of liquid ejecting heads. Through this, it is possible to prevent, with even more certainty, the ejection target medium from making contact with the grounding member and jamming.

Furthermore, according to another aspect of the invention, it is preferable that a liquid ejecting apparatus include the liquid ejecting head module described above, and a main apparatus unit that holds the liquid ejecting head module, and the anchoring member be electrically connected to the main apparatus unit.

According to this aspect, it is possible to realize a liquid ejecting apparatus capable of preventing the liquid ejecting heads from becoming charged and preventing the ejection target medium from coming into contact with the grounding member.

### BRIEF DESCRIPTION OF THE DRAWINGS

The invention will be described with reference to the accompanying drawings, wherein like numbers reference like elements.

FIG. 1 is a perspective view illustrating a head module according to a first embodiment.

FIG. 2 is a plan view illustrating the head module according to the first embodiment.

FIG. 3 is an exploded perspective view illustrating a head unit according to the first embodiment.

FIG. 4 is an exploded perspective view illustrating a head according to the first embodiment.

FIG. 5 is a plan view illustrating the head according to the first embodiment.

FIG. 6 is a cross-sectional view illustrating the head according to the first embodiment.

FIG. 7 is a perspective view illustrating the primary components of the head module according to the first embodiment.

FIG. 8 is a cross-sectional view illustrating the primary components of the head module according to the first embodiment.

FIG. 9 is a plan view of primary components, illustrating a relationship between a contact portion and an ejection target medium such as paper.

FIG. 10 is a perspective view illustrating a recording apparatus according to a second embodiment.

FIGS. 11A through 11C are plan views of primary components, illustrating states of a grounding member that has made contact with a cover head.

### DESCRIPTION OF EXEMPLARY EMBODIMENTS

### First Embodiment

The invention will be described in detail hereinafter based on embodiments. An ink jet recording head module (also called simply a “head module” hereinafter) described hereinafter is an example of a liquid ejecting head module; an ink jet recording head unit (also called simply a “head unit” hereinafter) is an example of a liquid ejecting head unit; and an ink jet recording head (also called simply a “head” hereinafter) is an example of a liquid ejecting head.

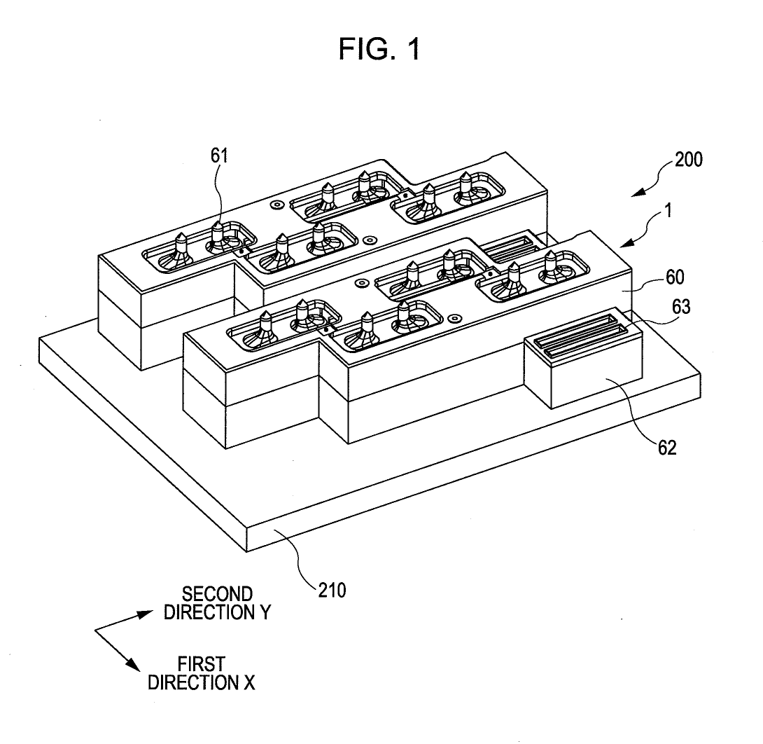

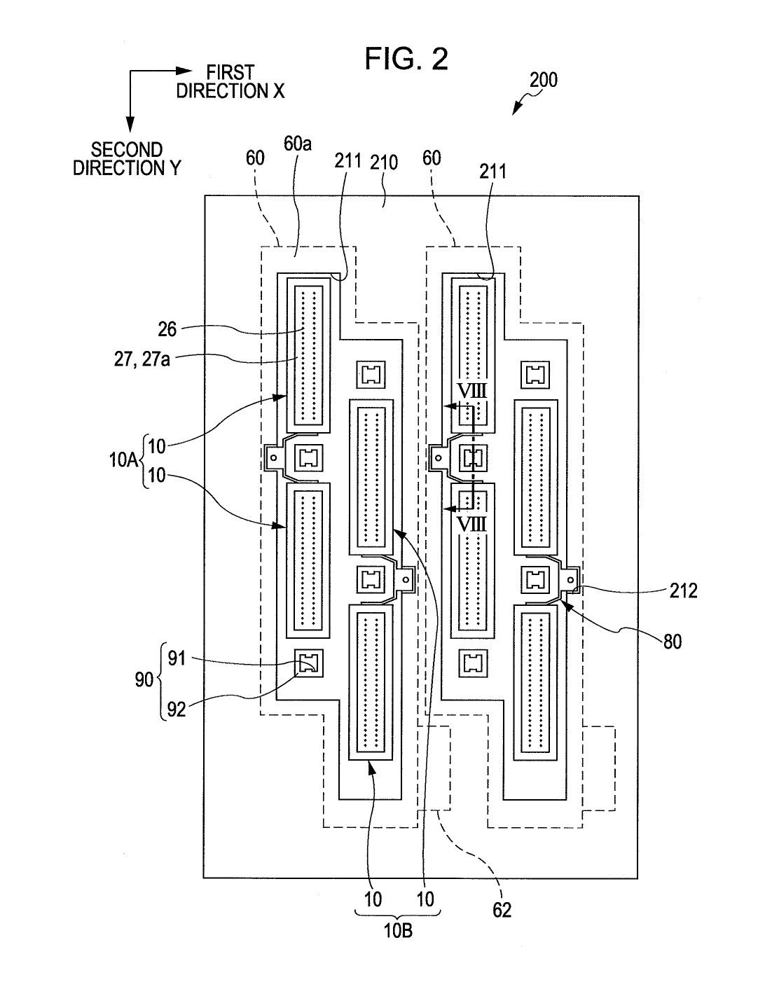

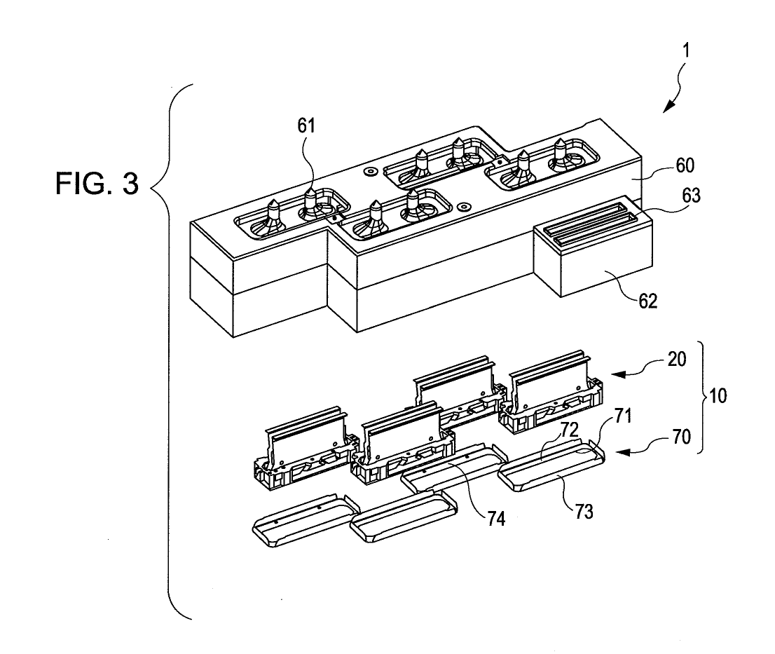

FIG. 1 is a perspective view illustrating a head module according to this embodiment; FIG. 2 is a plan view illustrating an ink jet recording head module according to this embodiment; and FIG. 3 is an exploded perspective view illustrating a head unit according to this embodiment.

As shown in FIGS. 1 and 2, a head module 200 includes a head unit 1 that is anchored to a carriage 210, which is an example of an anchoring member. In this embodiment, two head units 1 are anchored to the carriage 210.

Each head unit 1 includes a plurality of heads 10 and a holding member 60 that holds the heads 10. Although details will be given later, the plurality of heads 10 are provided in one side surface (a bottom surface 60a) of the holding member 60, so that nozzle openings 26 appear therein.

The carriage 210 is a member in which a conductive material such as metal has been formed in a plate shape, and is provided with two opening portions 211 that correspond to the respective head units 1. This carriage 210 is attached to an ink jet recording apparatus, which will be mentioned later, and moves relative to a recording sheet such as paper, which serves as a printing target. As shown in FIG. 2, the direction of the movement relative to the recording sheet is taken as a first direction X, whereas the direction orthogonal to the first direction X is taken as a second direction Y.

The two head units 1 are mounted on one of the surfaces of the carriage 210. Specifically, the sides of the head units 1 that face the bottom surface 60a of the holding member 60 (that is, the nozzle opening sides of the heads 10) are mounted to the peripheral edges of the opening portions 211 of the carriage 210, and the sides of the heads 10 on which the nozzle openings 26 are provided appear in the opening portions 211.

As shown in FIGS. 2 and 3, each head unit 1 includes a plurality (in this embodiment, four) of heads 10, and the holding member 60.

The holding member 60 is formed of, for example, a resin material, and includes in its interior a circuit board, a flow channel member in which ink communication channels are formed, a filter for removing dirt and bubbles, and so on. Ink supply pins 61 (in this embodiment, eight, as an example) are anchored to the upper surface (the surface on the opposite side as the heads 10) of the holding member 60. These ink supply pins 61 are connected, directly or via tubes, to reservoir units (not shown) that hold respective colors of ink. One ends of ink communication channels (not shown) communicate with the ink supply pins 61. The other ends of the ink communication channels open into a main head unit 20 (on the bottom surface side of the holding member 60). In other words, ink from an ink cartridge is supplied to the ink communication channels via the ink supply pins 61, and the supplied ink is then supplied to the main head unit 20 via ink introduction channels, which will be described in detail later.

The plurality of heads 10, which are positioned at predetermined intervals, are anchored to the bottom surface 60a of the holding member 60. The heads 10 are provided for each of the respective colors of ink.

The heads 10 that are held in this manner by the holding member 60 can form nozzle rows that are lengthened in the second direction Y at a constant pitch, by being disposed in a staggered manner in the second direction Y, which is the lengthwise direction of the heads 10. The “heads 10 disposed in a staggered manner” refers to the heads 10 disposed as described hereinafter. The plurality of heads 10 are arranged in the second direction Y, which is also the arrangement direction of the nozzle openings 26 (see FIG. 2). Two rows configured of the plurality (two) of heads 10 arranged in the second direction Y are provided in the first direction X, which is orthogonal to the direction in which the nozzle openings are arranged (that is, the second direction Y). In FIG. 2, the two rows configured of the two heads 10 arranged in the second direction Y are indicated by the reference numerals 10A and 10B. The two rows 10A and 10B of the heads 10 that are arranged in the first direction X are disposed so as to be slightly shifted from each other in the second direction Y. The nozzle openings 26 at the ends of the nozzle rows in the heads 10 of the one row 10A and the nozzle openings 26 at the ends of the nozzle rows in the heads 10 of the other row 10B are provided so as to be located in the same positions in the second direction Y.

Due to the plurality of heads 10 (in this embodiment, four heads 10), the nozzle rows are formed in a continuous manner by the four heads 10 worth of nozzle openings 26 being arranged in parallel at a constant pitch along the second direction Y, and thus the head unit 1 in which the heads 10 are arranged in such a staggered manner is capable of printing across a wide surface area along the width of the continuous nozzle rows.

Furthermore, because the plurality (in this embodiment, two) of head units 1 are arranged in the first direction X, the head module 200 achieves a further lengthening and densification of the nozzle rows.

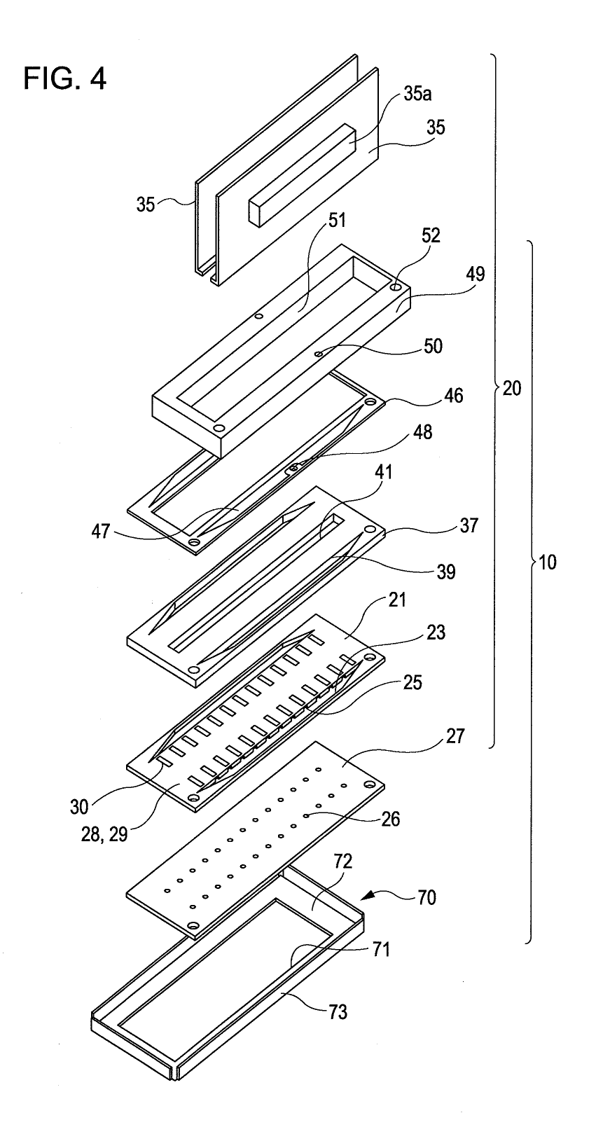

In addition, the holding member 60 includes an extension portion 62, which protrudes in the first direction X, on one side surface that is parallel to the second direction Y. Although not particularly shown in the drawings, a connector of a circuit board that is mounted inside is disposed within the extension portion 62, and external wiring is connected to a connector of a wiring board through a slit 63 provided in the upper surface of the extension portion 62. Note that the circuit board is connected to driving wires 35 (see FIG. 4) common for the plurality of heads 10.

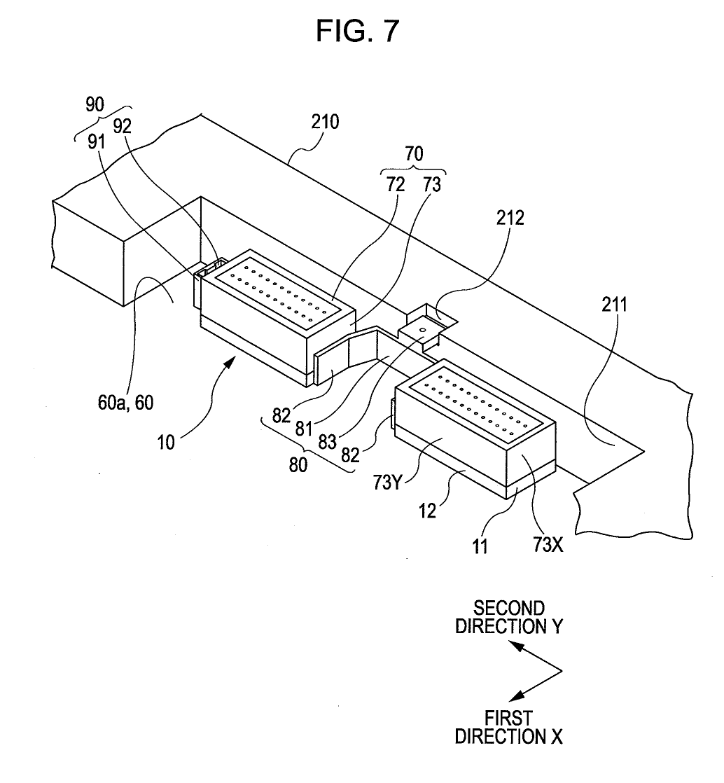

Furthermore, cap positioning portions 90 are provided in the bottom surface 60a of the holding member 60. Specifically, the cap positioning portions 90 are formed by providing positioning holes 92 that open into the top surface of protrusions 91 in those protrusions 91, the protrusions 91 being formed as rectangles from the bottom surface 60a. In this embodiment, two cap positioning portions 90 are provided in the holding member 60, for each of the rows 10A and 10B of the head unit 1. One of the two cap positioning portions 90 is disposed between the two heads 10 that configure the rows 10A and 10B. The other of the cap positioning portions 90 is disposed on a first side surface 11 (see FIG. 7) of one of the heads 10.

The cap positioning portions 90 are for regulating the positions of caps attached to liquid ejecting surfaces 27a of the heads 10, and details thereof will be given later.

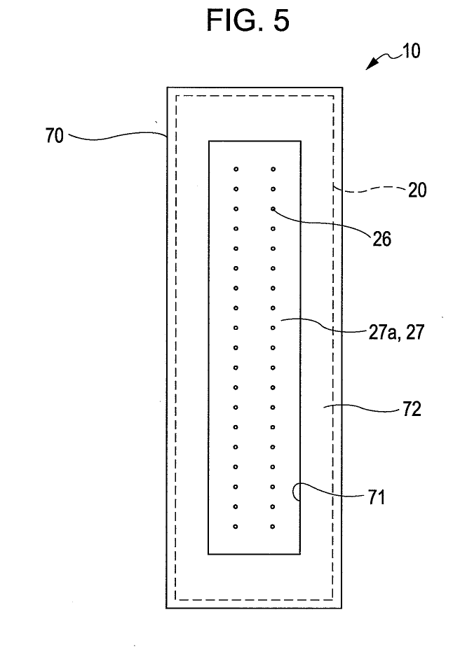

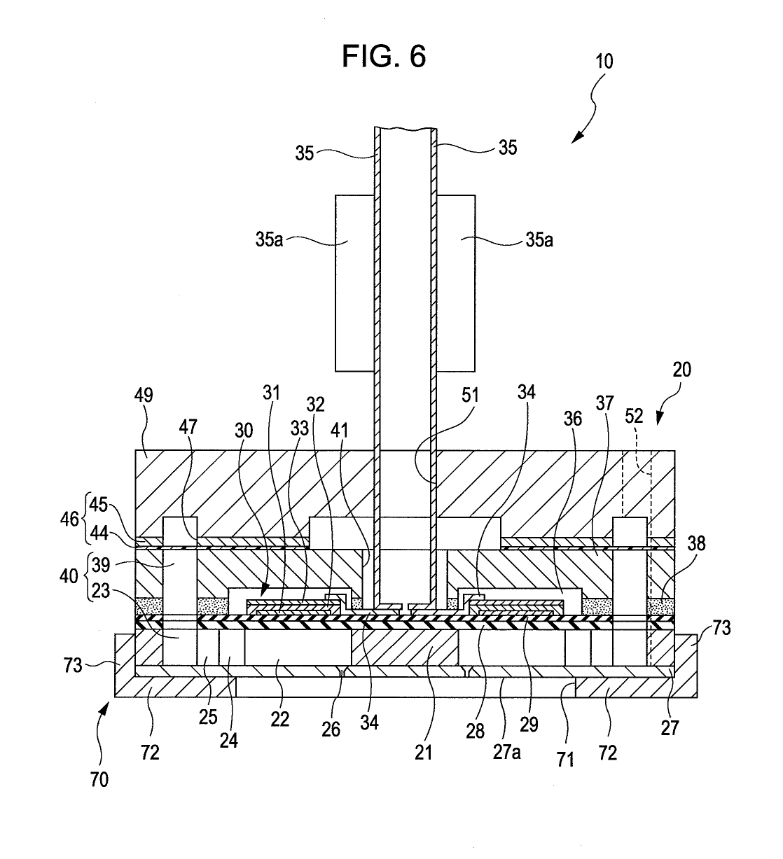

Here, an example of the configuration of the heads 10 will be described with reference to FIGS. 4 through 6. FIG. 4 is an exploded perspective view illustrating a head according to this embodiment, FIG. 5 is a plan view seen from the liquid ejecting surface side of the head, and FIG. 6 is a cross-sectional view taken along the lengthwise direction of a pressure generation chamber of the head. The “lengthwise direction of a pressure generation chamber” mentioned here refers to the direction (the first direction X, in FIG. 2) that is orthogonal to the direction (the second direction Y, in FIG. 2) in which the nozzle openings 26 are arranged.

As shown in the drawings, a plurality of pressure generation chambers 22 are provided in a flow channel formation plate 21 that partially configures the heads 10, with two rows of the pressure generation chambers 22 provided in the width direction thereof. Furthermore, communication portions 23 are formed in regions on the outer sides in the lengthwise direction of each row of pressure generation chambers 22, and the communication portions 23 and pressure generation chambers 22 communicate with each other via ink supply channels 24 and communication channels 25 provided for each of the pressure generation chambers 22.

A nozzle plate 27, in which are provided the nozzle openings 26 that communicate with the vicinity of the end of the opposite side of the pressure generation chambers 22 on which the ink supply channels 24 are located, is affixed to one surface of the flow channel formation plate 21.

Meanwhile, piezoelectric actuators 30 are formed on the surface of the flow channel formation plate 21 on the opposite side as the nozzle plate 27, with an elastic membrane 28 and an insulating membrane 29 provided therebetween. Each of the piezoelectric actuators 30 is configured of a first electrode 31, a piezoelectric layer 32, and a second electrode 33. A lead electrode 34 that extends to the top of the insulating membrane 29 is connected to the second electrode 33 of which each of the piezoelectric actuators 30 are configured. One end of the lead electrode 34 is connected to the second electrode 33, whereas the other end is connected to the driving wire 35, which serves as a flexible wiring member (a COF board) and to which is mounted a driving chip 35a for driving the piezoelectric actuator 30.

A protective substrate 37 that includes piezoelectric actuator holding portions 36, which are spaces for protecting the piezoelectric actuators 30, is affixed, using an adhesive 38, to the top of the flow channel formation plate 21 in which the piezoelectric actuators 30 are formed, in regions opposing the piezoelectric actuators 30. Furthermore, a manifold portion 39 is provided in the protective substrate 37. In this embodiment, the manifold portion 39 communicates with the communication portions 23 of the flow channel formation plate 21, configuring a manifold 40, which serves as a common ink chamber for the pressure generation chambers 22.

Meanwhile, a through-hole 41 that passes through the protective substrate 37 in the thickness direction thereof is provided in the protective substrate 37. The through-hole 41 is provided between the two piezoelectric actuator holding portions 36 in this embodiment. The vicinities of the ends of the lead electrodes 34, which are led out from their corresponding piezoelectric actuators 30, are provided so as to be exposed within the through-hole 41.

A compliance substrate 46, configured of a sealing membrane 44 and an anchoring plate 45, is further affixed to the top of the protective substrate 37. Here, the sealing membrane 44 is configured of a flexible material having a low rigidity, and one surface of the manifold portion 39 is sealed by the sealing membrane 44. The anchoring plate 45, meanwhile, is formed of a hard material such as a metal or the like. The region of the anchoring plate 45 that opposes the manifold 40 has an opening portion 47 in which the anchoring plate 45 has been completely removed in the thickness direction, and thus one surface of the manifold 40 is sealed using only the flexible sealing membrane 44. A compliance is imparted within the manifold 40 at the region that is sealed using only the sealing membrane 44. Furthermore, an ink introduction opening 48 for introducing ink into the manifold 40 is provided in the compliance substrate 46.

A head case 49, serving as a case member, is anchored to the top of the compliance substrate 46. An ink introduction channel 50 that communicates with the ink introduction opening 48 and supplies ink from the reservoir unit such as a cartridge to the manifold 40 is provided in the head case 49. Furthermore, a wiring member holding hole 51 that communicates with the through-hole 41 provided in the protective substrate 37 is provided in the head case 49, and one end of the driving wire 35 is connected to the lead electrode 34 as a state being inserted into the wiring member holding hole 51.

With such a main head unit 20 according to this embodiment, after ink from the reservoir unit (not shown) has been pulled in from the ink introduction opening 48 via the holding member and the interior spanning from the manifold 40 to the nozzle openings 26 has been filled with ink, voltages are applied to the respective piezoelectric actuators 30 corresponding to the pressure generation chambers 22 in accordance with recording signals from the driving chip 35a, which causes the elastic membrane 28, the insulating membrane 29, and the piezoelectric actuators 30 to bend and deform; as a result, the pressure in the pressure generation chambers 22 increases, and ink droplets are ejected through the nozzle openings 26.

Furthermore, the respective members of which such a main head unit 20 is configured are provided with positioning holes 52, in two locations at the corners on both sides in the lengthwise direction, into which pins for positioning the respective members are inserted during assembly. The main head unit 20 is formed in an integral manner by affixing the members to each other while positioning those members relative to each other by inserting the pins into the positioning holes 52.

A cover head 70, serving as a protective member, is anchored to the main head unit 20 on the side of the liquid ejecting surface 27a in which the nozzle openings 26 are provided in the nozzle plate 27.

The cover head 70 is a member that covers the side surfaces that are orthogonal to the surface of the nozzle plate 27, which are the liquid ejecting surfaces 27a of the heads 10. In this embodiment, the cover head 70 also covers the peripheral edges of the surface of the nozzle plate 27.

The cover head 70 has a box shape in which the edges of a rectangular plate-shaped member are bent and erected toward the side surfaces of the main head unit 20, and the bottom surface thereof is affixed to the surface of the nozzle plate 27, which is the liquid ejecting surface 27a, using an adhesive (not shown). Specifically, the cover head 70 includes: an exposure opening portion 71 that provides a rectangular opening for exposing the nozzle openings 26; and a rectangular frame portion 72 that defines the exposure opening portion 71 and is provided along the peripheral edges of the surface of the nozzle plate 27, which is the liquid ejecting surface. In addition, side wall portions 73 that extend so as to curve toward the side surfaces orthogonal to the liquid ejecting surface 27a of the main head unit 20 are provided in the cover head 70. The side wall portions 73 cover the four side surfaces of the main head unit 20.

The frame portion 72 has an external perimeter that is greater than the external perimeter of the nozzle plate 27, which is the liquid ejecting surface 27a, and the internal perimeter, or in other words, the exposure opening portion 71 that is defined by the frame portion 72, is smaller than the external perimeter of the nozzle plate 27. Accordingly, the frame portion 72 opposes the external perimeter edges of the nozzle plate 27, and is affixed to the peripheral edges of the nozzle plate 27 using an adhesive.

The cover head 70 configured in this manner is formed of a conductive material such as a metal. Although details will be given later, the cover head 70 is grounded to the ink jet recording apparatus, and electrical charge resulting from the heads 10 becoming charged is discharged to the exterior of the heads 10 from the nozzle plate 27 via the cover head 70 and so on.

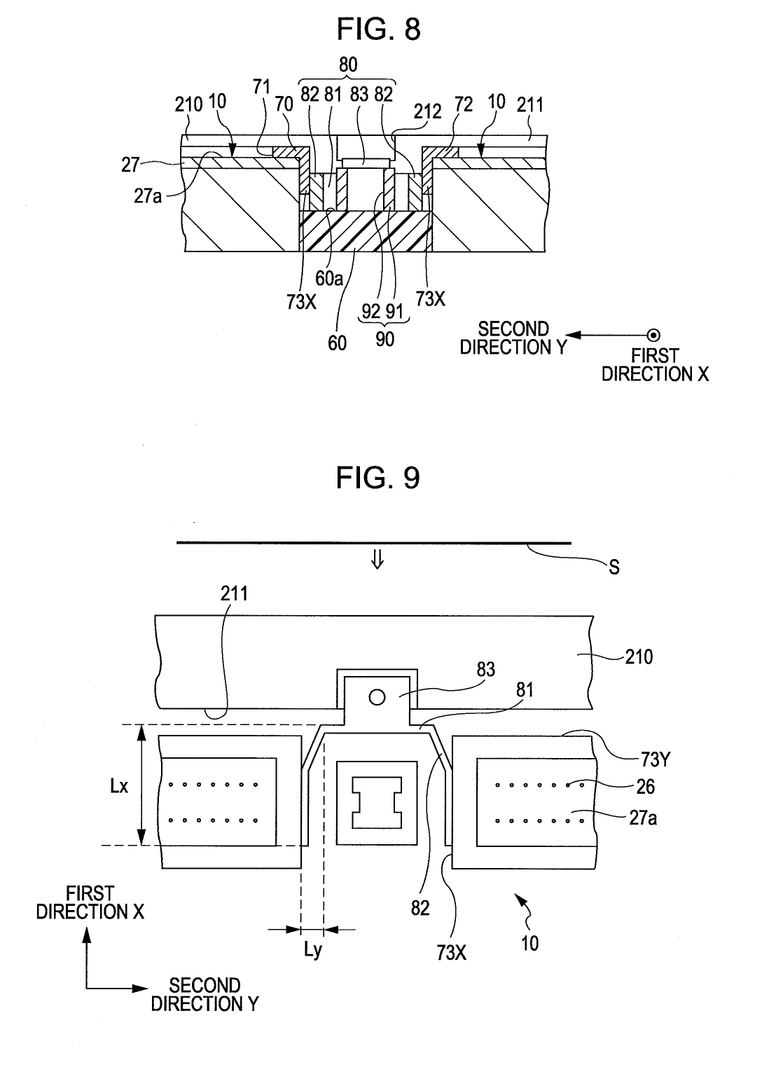

Here, a structure for grounding the heads of the head module to the carriage according to this embodiment will be described. FIG. 7 is a perspective view illustrating the primary components of the head module according to this embodiment, and FIG. 8 is a cross-sectional view in which the primary components have been enlarged, taken along the VIII-VIII line of FIG. 2. Note that in FIG. 7, the cap positioning portions 90 disposed between the heads 10 are not shown.

As shown in FIGS. 7, 8, and 2, the plurality of heads 10 are provided so that the nozzle openings 26 appear in the holding member 60 on the side of the bottom surface 60a. The portions of the heads 10 that protrude from the bottom surface 60a are almost covered by the cover head 70. In other words, the frame portion 72 covers the peripheral edges of the surface of the nozzle plate 27, and the side wall portions 73 cover the side surfaces of the heads 10.

The side surfaces of the heads 10 are side surfaces orthogonal to the surface of the nozzle plate 27, which is the liquid ejecting surface 27a. In this embodiment, each of the heads 10 takes its side surfaces that are parallel to the first direction X as the first side surfaces 11, and the side surfaces that are parallel to the second direction Y as second side surfaces 12. Meanwhile, of the side wall portions 73 of the cover head 70, those that cover the first side surfaces 11 parallel to the first direction X are taken as side wall portions 73X, whereas those that cover the second side surfaces 12 parallel to the second direction Y are taken as side wall portions 73Y. A grounding member 80 is electrically connected to the side wall portions 73X of the cover head 70.

The grounding member 80 is a member that electrically connects the heads 10 to the carriage 210 and that is formed of a conductive material such as a metal. Specifically, the grounding member 80 includes: a plate-shaped main body portion 81; contact portions 82 that extend from both ends of the main body portion 81 and that are bent to one surface thereof; and a connection portion 83 that extends from the main body portion 81. In other words, two contact portions 82 are formed by bending both ends of the main body portion 81 so as to oppose each other. The contact portions 82 function as a plate spring whose bent portions serve as base end portions.

A single grounding member 80 configured in this manner is disposed between the two heads 10 that configure the row 10A. Likewise, a single grounding member 80 is also disposed between the two heads 10 that configure the row 10B. Specifically, for each of the rows 10A and 10B, the grounding member 80 is disposed between the two heads 10 so that the main body portion 81 is approximately parallel to the second direction Y and so that the contact portions 82 are approximately parallel to the first direction X.

The contact portions 82 make contact with respective side wall portions 73X of the cover head 70. In other words, the contact portions 82 make contact with the opposing side wall portions 73X of the respective two heads 10 of which the row 10A is configured. The same applies to the row 10B. The two contact portions 82 are pressurized by the side wall portions 73, and thus elastically deform toward each other. Accordingly, the restorative force of the contact portions 82 acts toward the side wall portions 73X, making the contact between the contact portions 82 and the side wall portions 73X more secure.

In addition, the connection portion 83 of the grounding member 80 protrudes from the main body portion 81 in the direction in which ink is ejected (that is, in the direction orthogonal to the first direction X and the second direction Y), and is bent in the opposite direction as the contact portions 82 bend. A groove portion 212 that continues into the opening portions 211 is formed in the surface of the carriage 210, and the connection portion 83 makes contact with the base surface of this groove portion 212. The depth of the groove portion 212 from the surface of the carriage 210 is greater than the thickness of the connection portion 83, and thus the connection portion 83 that has made contact with the base surface of the groove portion 212 is prevented from protruding beyond the surface of the carriage 210. Although not particularly illustrated, it should be noted that the connection portion 83 is anchored to the carriage 210 using a member such as a screw or the like.

As described thus far, the cover head 70, the grounding member 80, and the carriage 210 are formed of a conductive material, and thus the heads 10 are electrically connected to the carriage 210 via the nozzle plate 27, the cover head 70 (the side wall portions 73X), and the grounding member 80. Through this, an electrical charge that has built up in the heads 10 is discharged to the carriage 210. The heads 10 are prevented from being charged in this manner, and thus the heads 10 can be prevented from damage with certainty, where, for example, the piezoelectric actuators 30, driving chip 35a, or the like are damaged by static electricity that has built up in the nozzle plate. Although details will be given later, it should be noted that the carriage 210 is electrically connected to the ink jet recording apparatus itself, and the heads 10 are thus grounded to the ink jet recording apparatus via the carriage 210.

In addition, the heights of the various portions of the heads 10 and so on in the ink ejection direction (that is, the direction orthogonal to the first direction X and the second direction Y) are as shown in FIG. 8, using the bottom surface 60a of the holding member 60 as a reference. In other words, the liquid ejecting surfaces 27a of the heads 10 are lower than the surface of the carriage 210 (that is, are located toward the bottom surface 60a). The uppermost surface of the cap positioning portions 90 is lower than the liquid ejecting surfaces 27a of the heads 10. The height of the contact portions 82 of the grounding member 80 from the bottom surface 60a (the “one surface” of the holding member described in the aspects of the invention) is lower than the cap positioning portions 90. In addition, the grounding member 80 as a whole is lower than the liquid ejecting surfaces 27a of the heads 10.

In other words, during printing, the heads 10 are closest to the paper surface, and the contact portions 82, cap positioning portions 90, and so on are distanced from the paper surface. Accordingly, it is difficult for the contact portions 82 (the grounding member 80) to come into contact with the paper surface during printing, which prevents paper jams.

Furthermore, the contact portions 82 of the grounding member 80 are caused to make contact with the side wall portions 73X of the cover head 70 that are parallel to the first direction X, which makes it even more difficult for paper jams to occur. This will be described in detail using FIG. 9.

FIG. 9 is a plan view of primary components, illustrating a relationship between the contact portions that make contact with the cover head and an ejection target medium such as paper. As shown in FIG. 9, the contact portions 82 of the grounding member 80 are formed as plate shapes, and make contact with respective side wall portions 73X of the cover head 70. The side wall portions 73X are parallel to the first direction X, which is the direction in which the carriage 210 moves relative to a recording sheet S. Accordingly, the contact portions 82 that make contact with the side wall portions 73X are almost parallel to the first direction X along the side wall portions 73X. By employing such a configuration, lengths Ly of the second direction Y components of the contact portions 82 are shorter than lengths Lx of the first direction X components, and are equivalent to the thickness of the contact portions 82.

In other words, the lengths Ly of the second direction Y components of the contact portions 82 relative to the width (that is, the length in the second direction Y) of the recording sheet S transported in the first direction X are equivalent to the thickness of the contact portions 82. Accordingly, it is even more difficult for the contact portions 82 to make contact with the recording sheet S, which makes it possible to more certainly prevent the recording sheet S from coming into contact with the contact portions 82 (the grounding member 80) and causing paper jams.

As described thus far, with the head module 200 according to this embodiment, the heads 10 are electrically connected to the carriage 210 via the grounding member 80, and thus charges that have built up in the heads 10 are discharged.

The contact portions 82 that are formed in the plate shape of the grounding member 80 make contact with the side wall portions 73X of the cover head 70 that are parallel to the first direction X, which is the direction in which the carriage 210 moves relative to the recording sheet S. Accordingly, with the head module 200, the lengths Ly of the second direction Y components of the contact portions 82 are equivalent to the thickness of the contact portions 82, which makes it difficult for the contact portions 82 to come into contact with the recording sheet S and prevents paper jams with more certainty.

In addition, because the plurality (in this embodiment, two) of heads 10 are electrically connected to the single grounding member 80, the number of grounding members 80 can be reduced, which makes it possible to reduce the cost of the head module 200.

Here, assuming that the frame portion 72 of the cover head 70 is mounted on the peripheral edges of the opening portions 211 in the carriage 210 and the heads 10 are directly grounded to the carriage 210, the weight of the heads 10 themselves and the weight of the holding member 60 are exerted on the heads 10. In this case, the positions of the heads 10 will shift, and burdens will be placed on the members of which the heads 10 are configured.

However, with the head module 200 according to this embodiment, the heads 10 are not mounted to the carriage 210, and are electrically connected to the carriage 210 via the grounding member 80 in an indirect manner. According to such a configuration, the burden placed on the heads 10 is reduced, and thus burdens can be prevented from being exerted on the members of which the heads 10 are configured, and the heads 10 can be prevented from shifting positions. In addition, when the heads 10 are positioned relative to the carriage 210, the dimensional tolerance of the cover head 70 has no influence, and thus the positioning can be carried out with a high degree of precision.

### Second Embodiment

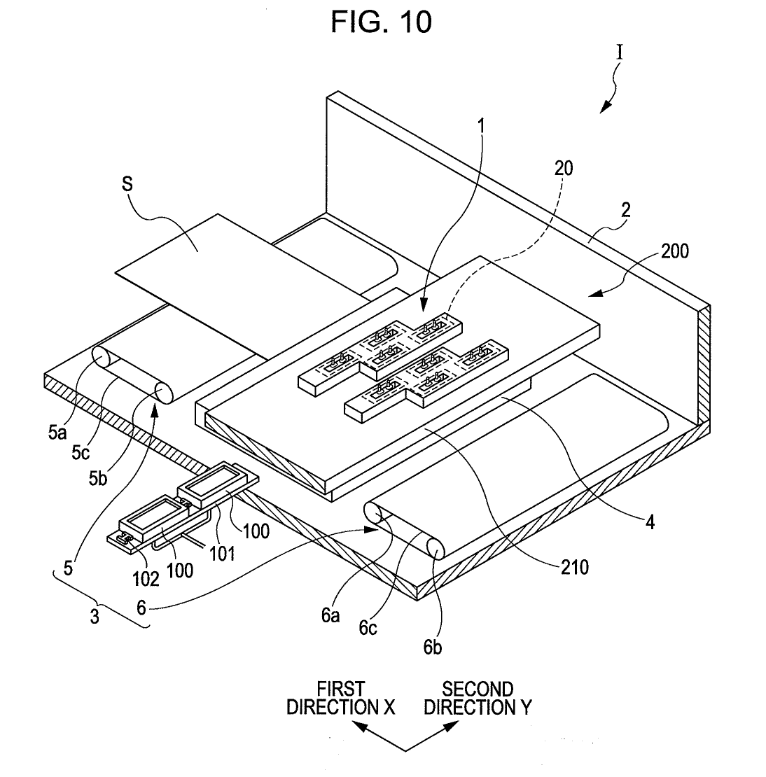

The head module 200 described in the first embodiment is mounted in an ink jet recording apparatus, which is an example of a liquid ejecting apparatus. FIG. 10 is a general perspective view illustrating an ink jet recording apparatus serving as an example of a liquid ejecting apparatus according to a second embodiment of the invention. Note that elements identical to those in the first embodiment are given the same reference numerals, and redundant descriptions thereof will be omitted.

As shown in FIG. 10, an ink jet recording apparatus I according to this embodiment is what is known as a line-type recording apparatus, in which the head module 200 is anchored and printing is carried out by transporting the recording sheet S such as paper, which serves as an ejection target medium. The first direction X is the direction in which the carriage 210 moves relative to the recording sheet S, whereas the second direction Y is the direction orthogonal to the first direction X.

Specifically, the ink jet recording apparatus I includes: a main apparatus unit 2; the head module 200, which is anchored to the main apparatus unit 2; a transport unit 3 that transports the recording sheet S, which is the ejection target medium; and a platen 4 that supports the recording sheet S from the rear surface thereof, which is on the opposite side as a printing surface that faces the head module 200.

The head module 200 is anchored to the main apparatus unit 2 so that the direction in which the nozzle openings 26 of the heads 10 are arranged is the second direction Y that is orthogonal to the transport direction of the recording sheet S (the first direction X).

The transport unit 3 includes a first transport unit 5 and a second transport unit 6 that are provided on either side of the head module 200 in the transport direction of the recording sheet S.

The first transport unit 5 is configured of a driving roller 5a, a slave roller 5b, and a transport belt 5c that is stretched upon the driving roller 5a and the slave roller 5b. Like the first transport unit 5, the second transport unit 6 is configured of a driving roller 6a, a slave roller 6b, and a transport belt 6c.

The driving rollers 5a and 6a of the first transport unit 5 and the second transport unit 6, respectively, are connected to a driving unit such as a driving motor (not shown), and the transport belts 5c and 6c are rotationally driven by the driving force of the driving unit; as a result, the recording sheet S is transported from upstream to downstream of the head module 200.

Although this embodiment illustrates the first transport unit 5 and the second transport unit 6, which are configured of the driving rollers 5a and 6a, the slave rollers 5b and 6b, and the transport belts 5c and 6c, respectively, it should be noted that a holding unit that holds the recording sheet S upon the transport belts 5c and 6c may further be provided. As an example of the holding unit, a charging unit that charges the outer surface of the recording sheet S may be provided, and the recording sheet S that has been charged by the charging unit may be caused to adhere to the transport belts 5c and 6c through the effects of induced polarization. Alternatively, as another example of the holding unit, a pressure roller may be provided above the transport belts 5c and 6c, and the recording sheet S may be compressed between the pressure roller and the transport belts 5c and 6c.

The platen 4 is configured of metal, a resin, or the like that has a rectangular cross-sectional shape, and is provided between the first transport unit 5 and the second transport unit 6 so as to oppose the head module 200. The platen 4 supports the recording sheet S that has been transported by the first transport unit 5 and the second transport unit 6 at a position that opposes the head module 200.

Note that the platen 4 may be provided with an attraction unit that attracts the transported recording sheet S onto the platen 4. A unit that attracts the recording sheet S through suction by sucking the recording sheet S, a unit that attracts the recording sheet S using the force of static electricity, or the like can be given as examples of the attraction unit.

Furthermore, although not shown, an ink reservoir unit, such as an ink tank or a ink cartridge that holds ink, is connected to the head module 200 so as to be capable of supplying ink thereto. The ink reservoir unit may, for example, be held upon the head module 200, or may be held in a different location in the main apparatus unit 2 than the head module 200 and connected to the ink supply pins 61 of the head units 1 via tubes or the like. Furthermore, external wires (not shown) are connected to the head units 1 of the head module 200.

With such an ink jet recording apparatus I, the recording sheet S is transported by the first transport unit 5, and the head module 200 executes printing on the recording sheet S supported by the platen 4. The recording sheet S that has been printed on is then transported by the transport unit 3.

Meanwhile, the ink jet recording apparatus I periodically carries out cleaning for discharging bubbles. This cleaning eliminates bubbles by sealing the liquid ejecting surfaces 27a using caps 100 provided in the nozzle plate 27 (see FIG. 2), instigating a negative pressure, and sucking ink from the nozzle openings 26 of the nozzle plate 27.

Two of these caps 100 are provided on a base portion 101, and the base portion 101 is configured so as to be capable of moving in the first direction X, the second direction Y, and the direction orthogonal to those directions.

Two connectors 102 for fitting with the positioning holes 92 of the cap positioning portions 90 are provided in the base portion 101. The connectors 102 are disposed so that when the connectors 102 fit with the positioning holes 92, the caps 100 cover the liquid ejecting surfaces 27a.

This base portion 101 moves so that the connectors 102 fit with the positioning holes 92. Through this, the caps 100 are positioned relative to their corresponding liquid ejecting surfaces 27a, and the liquid ejecting surfaces 27a are covered by the caps 100. The aforementioned cleaning is carried out in this state.

Although the example shown in FIG. 10 illustrates what is known as a line-type ink jet recording apparatus I in which the head units 1 (head module 200) are anchored to the main apparatus unit 2 and the printing is carried out simply by moving the recording sheet S, it should be noted that the invention is not particularly limited thereto; for example, the invention can also be applied in what is known as a serial-type recording apparatus in which the head units 1 (head module 200) are mounted in a carriage that moves in the main scanning direction that is orthogonal to the transport direction of the recording sheet S and printing is carried out while the head units 1 (head module 200) move in the main scanning direction.

### Other Embodiments

Although embodiments of the invention have been described thus far, the basic configuration of the invention is not intended to be limited to the aforementioned descriptions.

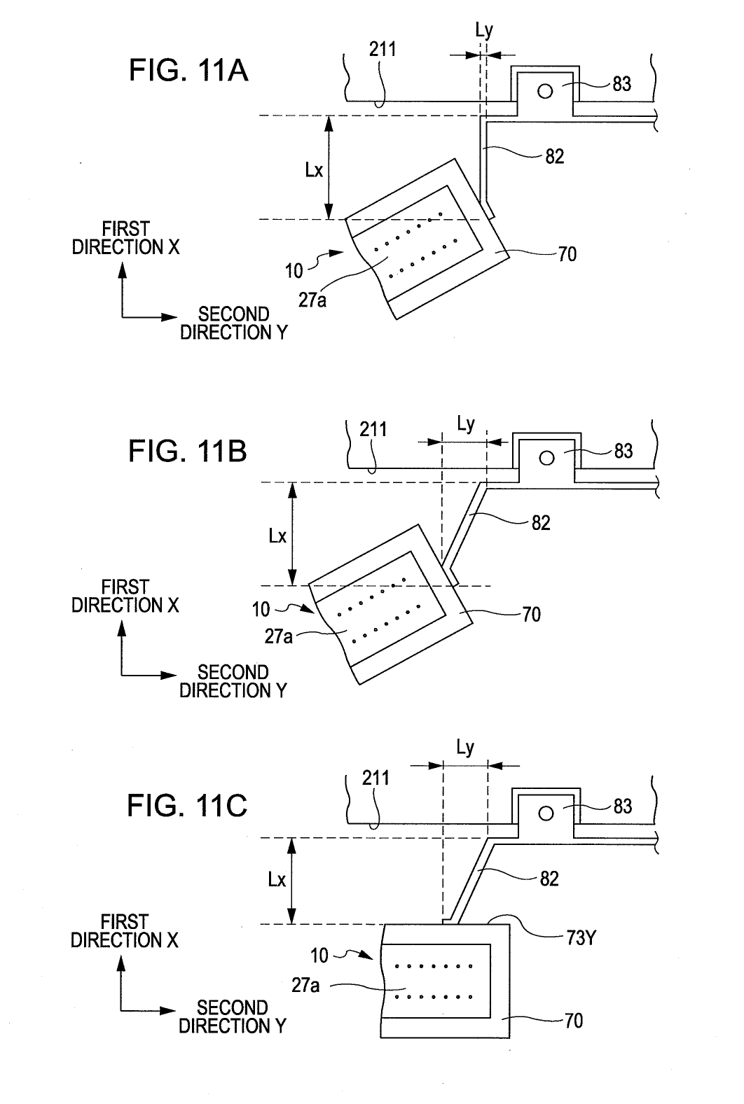

Although the side wall portions 73X are described as being parallel to the first direction X in the aforementioned embodiment, the invention is not limited thereto. For example, as shown in FIG. 11A, the side surfaces of the cover head 70 may be tilted relative to the first direction X. In this case, the contact portions 82 and the side surfaces are caused to make contact by bending the end portions of the contact portions 82 that extend in the first direction X so as to follow the stated side surfaces.

In addition, although the contact portions 82 are described as being disposed so as to be approximately parallel to the first direction X, the invention is not limited thereto. For example, as shown in FIG. 11B, the contact portions 82 may be intersected with the first direction X. Furthermore, as shown in FIG. 11C, the contact portions 82 may make contact with the side wall portions 73Y of the cover head 70 that are parallel to the second direction Y.

Any of the examples shown in FIGS. 11A through 11C may be used as long as the lengths Ly of the second direction Y components of the contact portions 82 are shorter than the lengths Lx of the first direction X components. Accordingly, it is difficult for the contact portions 82 (the grounding member 80) to come into contact with the recording sheet S, which prevents paper jams with more certainty.

The “length of the first direction component” of the grounding member as described in the aspects of the invention refers to the length of the first direction component of the grounding member spanning from the position where the grounding member is anchored to the anchoring member (the carriage) to the position at which the grounding member comes into contact with a protective member. Meanwhile, the “length of the second direction component” of the grounding member as described in the aspects of the invention refers to the length of the second direction component of the grounding member spanning from the position where the grounding member is anchored to the anchoring member (the carriage) to the position at which the grounding member comes into contact with a protective member.

In the first embodiment, the length of the first direction X component of the grounding member 80 is the length Lx of the first direction X component spanning from the main body portion 81, which is the anchoring position with the carriage 210, to the position of contact with the cover head 70. Likewise, the length of the second direction Y component of the grounding member 80 is the length Ly of the second direction Y component from the main body portion 81 to that position of contact.

In addition, although the grounding member 80 includes the main body portion 81 and the connection portion 83 in addition to the contact portions 82, the invention is not limited to such a form. For example, the grounding member 80 may be configured only of the contact portions 82, or in other words, as a plate-shaped grounding member. In this case, the grounding member is configured so as to make contact with the side wall portions 73X of the cover head 70 and so as to make contact with the carriage 210.

Furthermore, the head module 200 is not limited to having the two head units 1 anchored thereto. The head module may have one or a plurality of head units 1 provided therein. In addition, although four heads 10 are described as being provided in each head unit 1, the invention is not limited thereto. The head unit may have one or a plurality of heads 10 provided therein.

Although the carriage 210 attached to the ink jet recording apparatus I is given as an example of the anchoring member, the invention is not limited thereto. The head units 1 may be anchored to a member aside from the carriage and that member may be taken as the head module, and the head module may then be attached to the carriage and provided in the ink jet recording apparatus I.

Although thin-film type piezoelectric actuators 30 are described as being used as the pressure generation units that cause pressure changes in the pressure generation chambers 22 in the aforementioned embodiments, the invention is not particularly limited thereto; for example, a thick-film piezoelectric actuator formed through a method such as applying a green sheet, a longitudinally-vibrating piezoelectric actuator that extends and contracts in the axial direction, formed by alternately layering piezoelectric material and electrode formation material, and so on can be used as well. Moreover, a device in which heating elements are disposed within the pressure generation chambers and liquid is discharged through the nozzle openings due to bubbles forming as a result of the heat from the heating elements, a so-called electrostatic actuator that generates static electricity between a vibration plate and an electrode, with the resulting static electricity force causing the vibration plate to distort and liquid to be discharged from the nozzle openings, can also be used as the pressure generation units.

Although the aforementioned embodiments describe an ink jet recording head as an example of a liquid ejecting head, it should be noted that the invention is targeted at liquid ejecting heads in general, and thus can of course be applied in liquid ejecting heads that eject liquids aside from ink. Various types of recording heads used in image recording apparatuses such as printers, coloring material ejecting heads used in the manufacture of color filters for liquid-crystal displays and the like, electrode material ejecting heads used in the formation of electrodes for organic EL displays, FEDs (field emission displays), and so on, bioorganic matter ejecting heads used in the manufacture of biochips, and so on can be given as other examples of liquid ejecting heads.

The entire disclosure of Japanese Patent Application No. 2011-050861, filed Mar. 8, 2011 is incorporated by reference herein.

What is claimed is:

1. A liquid ejecting head module comprising:
a head unit including a plurality of liquid ejecting heads, each liquid ejecting head having a liquid ejecting surface in which nozzle openings that eject a liquid are provided;
an anchoring member, to which the head unit is anchored, that moves in a first direction relative to an ejection target medium onto which the liquid is ejected; and
a grounding member that electrically connects the liquid ejecting heads to the anchoring member,
wherein a protective member that covers the side surfaces of the liquid ejecting heads that are orthogonal to the liquid ejecting surfaces is provided for each of the liquid ejecting heads; and
the grounding member makes contact with the protective members, and the length of a second direction component of the grounding member that is orthogonal to the first direction is shorter than the length of the first direction component of the grounding member.

2. The liquid ejecting head module according to claim 1,
wherein the grounding member is formed in a plate shape; and
the grounding member makes contact with surfaces of the protective members that are parallel to the first direction.

3. The liquid ejecting head module according to claim 1,
wherein the head unit includes a holding member that holds the plurality of liquid ejecting heads on one surface;
a cap positioning portion that regulates the positions of caps attached to corresponding liquid ejecting surfaces of the liquid ejecting heads is provided on the one surface of the holding member; and
the height of the grounding member from the one surface is lower than the height of the cap positioning portion.

4. The liquid ejecting head module according to claim 1,
wherein the grounding member makes contact with each protective member of the plurality of liquid ejecting heads.

5. A liquid ejecting apparatus comprising:
the liquid ejecting head module according to claim 1; and
a main apparatus unit that holds the liquid ejecting head module,
wherein the anchoring member is electrically connected to the main apparatus unit.

6. A liquid ejecting apparatus comprising:
the liquid ejecting head module according to claim 2; and
a main apparatus unit that holds the liquid ejecting head module,
wherein the anchoring member is electrically connected to the main apparatus unit.

7. A liquid ejecting apparatus comprising:
the liquid ejecting head module according to claim 3; and
a main apparatus unit that holds the liquid ejecting head module,
wherein the anchoring member is electrically connected to the main apparatus unit.

8. A liquid ejecting apparatus comprising:
the liquid ejecting head module according to claim 4; and
a main apparatus unit that holds the liquid ejecting head module,
wherein the anchoring member is electrically connected to the main apparatus unit.
